(19) United States
(12) Patent Application Publication
(10) Pub. No.: US 2006/0001741 A1
(43) Pub. Date: Jan. 5, 2006

(54) Realtime video display method of mixed signals

(76) Inventors: Huei Lan Hsu, Hsinchu (TW); Chen Lung Chen, Hsinchu (TW); Chi Sheng Cheng, Hsinchu (TW); Chung Ho Chang, Hsinchu (TW); Wen Kai Lin, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/006,542

(22) Filed: Dec. 8, 2004

(30) Foreign Application Priority Data
Jun. 30, 2004 (TW) 93119566

(51) Int. Cl. H04N 7/18

(52) U.S. Cl. 348/143; 348/207.1

(57) ABSTRACT

A realtime video display method of mixed signals applies to a monitoring system. The monitoring system has a monitoring host connected to a plurality of digital monitoring devices and a plurality of analog monitoring devices. In this method, digital video data from an Internet/LAN/WAN and analog video data from a transmission interface are first received. Next, a data fetch server is used to collect the video data for processing and then output the processed image data to a data mixer. The data mixer then merges the digital video data and the analog video data into a signal mixing different data sources. The digital video data and the analog video data can thus be displayed at a browse terminal in real time. Therefore, signals of different types can be integrated for realtime display on the same management screen to effectively exploit a real benefit of security management.

### FIELD OF THE INVENTION

The present invention relates to a video display method of surveillance systems and, more particularly, to a video display method capable of displaying the video images from the mixed signals in real time.

### BACKGROUND OF THE INVENTION

Nowadays, security systems are more and more appreciated in every aspect. The emerging demand of integrated digital surveillance is continuously growing, resulted in recent terrorism and crime wave as well as the needs of global enterprises. The requirement of remote monitoring through the Internet is steadily increased.

Generally speaking, surveillance systems mainly include access control systems, alarm/burglarproof systems, and video management systems. The video management system integrates the techniques of camera image input, image processing, and record display. Analog closed-circuit television (CCTV) is the most popular monitoring system today. The disadvanges of CCTV monitoring systems include the quality issue of videotape, signal attenuation, and poor image quality etc., however, they still predominate due to their low prices. Besides, along with digitization and increase of the requirement for remote monitoring, digital image monitoring systems have become the development trend in the future surveillance market and LAN cameras are used for capturing images.

In existent surveillance systems, analog signals and digital signals coexist for image display. However, a digital surveillance system can only display digital images, and an analog image monitoring system can only display analog images. Therefore, the present invention aims to propose a realtime video display method of mixed signal so that analog images and digital images can be displayed in real time for video monitoring.

### SUMMARY OF THE INVENTION

An object of the present invention is to provide a realtime video display method of mixed signals, with which analog images and digital images are simultaneously received and displayed on the video monitoring system, hence solving the problem of incompatibility of conventional digital and analog monitoring systems.

Another object of the present invention is to let a user be able to connect a monitoring host via the Internet or an intranet for realtime monitoring of image and checking the information of access control and various detectors, hence effectively exploiting a real benefit of surveillance management.

To achieve the above objects, the present invention proposes a realtime video display method of mixed signal applied to a video monitoring system. The monitoring system has a monitoring host, which is connected to a plurality of analog monitoring devices via a transmission interface and to a plurality of digital monitoring devices via an Internet/WAN (wide area network)/local area network (LAN). In this method, the digital video data from the Internet/WAN/LAN and the analog video data from the transmission interface are first received. Next, a data fetch server is used to collect the video data for processing and then output the processed video data to a data mixer. The data mixer then merges the digital video data and the analog video data into a signal data source. The digital video data and the analog video data can thus be displayed at a browse terminal in real time.

The various objects and advantages of the present invention will be more readily understood from the following detailed description when read in conjunction with the appended drawing, in which:

### BRIEF DESCRIPTION OF THE DRAWINGS

FIG. 1 is an architecture diagram of a video monitoring system to which the present invention is applied; and

FIG. 2 is a flowchart of a realtime video display method of mixed signals of the present invention.

### DETAILED DESCRIPTION OF THE PREFERRED EMBODIMENTS

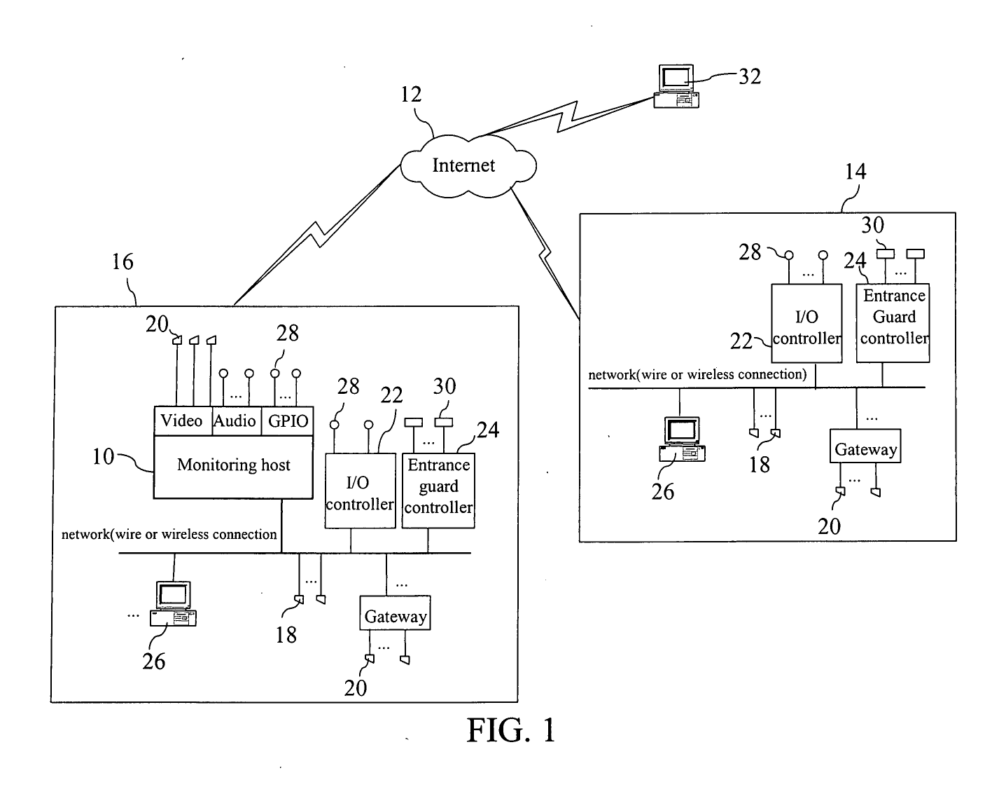

The present invention proposes a realtime video display method applied to a video management system. As shown in FIG. 1, the video management system comprises a monitoring host 10 connected to a plurality of external networks 14 via the Internet 12 and to an intranet 16 via a wide area network (WAN)/local area network (LAN). A plurality of digital monitoring devices 18 (i.e., IP cameras) is disposed in the external networks 14 and the intranet 16. The external networks 14 and the intranet 16 are of TCP/IP architecture, and are usually Ethernet networks. Each of the digital monitoring devices 18 has an IP address assigned to it. The external networks 14 and the intranet 16 are connected with a plurality of analog monitoring devices 20 via a transmission interface. For internal buses, the transmission interface is usually a peripheral component interconnect (PCI). For external buses, the transmission interface is usually universal serial bus (USB) or IEEE 1394 (fire wire). Besides, an I/O controller 22, an access controller 24, and a local browse device 26 are disposed in each of the external networks 14 and the intranet 16. The I/O controller 22 is connected with a plurality of detectors 28. The access controller 24 is connected with several card readers 30 for access controlling. A local security personnel can use the local browse device 26 to browse local captured images. The detectors 28 usually include components like magnetic contacts, infrared detectors, microwave spatial detectors, glass vibration detectors, smoke detectors, temperature sensors, gas detectors, flame detectors, carbon monoxide detectors, poisonous gas detectors, emergency push-buttons, wireless help seekers, flash alarms, or indication lights.

A remote browse terminal 32 is connected with the intranet 16 and the external networks 14 via the Internet 12 so that digital images and analog images can be displayed in real time for remote monitoring.

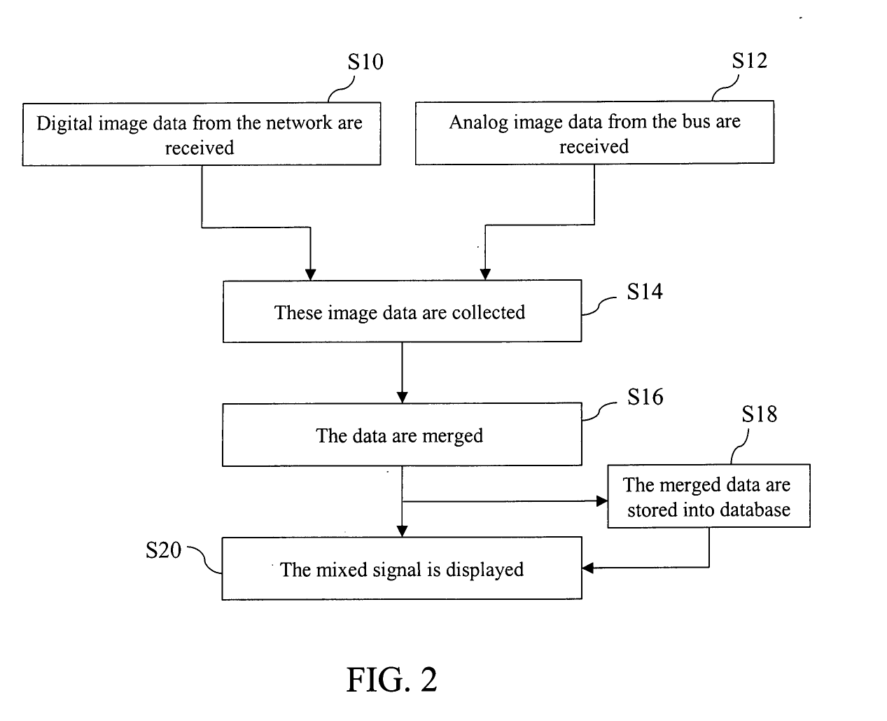

FIG. 2 is a flowchart of a realtime video display method of mixed signals of the present invention. The method comprises the following steps. First, a network communication device is connected to Internet/WAN/LAN and an analog device is connected to a computer bus. Digital video data from the Internet/WAN/LAN is received (Step S10), and analog image data from the bus is received simultaneously (Step S12). The digital video data is captured by a digital monitoring device, and the analog video data is captured by an analog monitoring device. Next, a data fetch server is used to collect the image data and send the analog video for subsequent processing so that the monitoring host can view the analog video data as one whose source is a digital monitoring device (Step S14).

After processing of the analog video data, the digital video data and the analog video data are together sent to a data mixer. The data mixer will synchronously process the digital video data and the analog video data to merge mixed signal sources (Step S16). The data mixer can receive image data of different video formats. The format of digital video image is usually MPEG, MPEG2, MPEG4, H.263, or H.264. The format of analog video image is usually NTSC or PAL. After the mixed data sources are formed by merging, they are stored into a database and can be displayed on a browse terminal (Step S18). Finally, the browse terminal can receive the digital signal via the database or the data mixer for realtime and simultaneous display of digital video data and analog video data.

The digital signal with mixed data sources can be displayed on the same screen or can display on different screens simultaneously. The browse terminal can be a local browse terminal or a remote browse terminal. If the browse terminal is a remote browse terminal, it is connected to the monitoring host via a network and makes use of a network viewer (e.g., the Microsoft's IE explorer) to browse the simultaneously displayed digital video and analog video. Moreover, the captured video can be shown on the same monitoring screen, and the video source can be from the analog monitoring devices and/or the digital monitoring devices.

The above realtime video display method of mixed signal can be integrated with the same software.

Therefore, when the present invention is used in monitoring, analog video from common monitoring cameras can be received, and digital video from IP cameras can also be received. That is, signals of different types can be integrated for realtime display on the same management screen, hence solving the problem of incompatibility of conventional digital and analog monitoring systems. Besides, a user can connect the monitoring host via the Internet or an intranet for realtime monitoring of image, access control, and messages of various detectors, hence effectively exploiting a real benefit of safety management.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A realtime video display method of mixed signals applied to a monitoring system, said monitoring system comprising a monitoring host connected to a plurality of digital monitoring devices via an Internet/LAN/WAN and to a plurality of analog monitoring devices via a transmission interface, said realtime video display method of mixed signal comprising the steps of:
receiving a digital video data from said Internet/LAN/WAN and an analog video data from said transmission interface, respectively;
using a data fetch server to collect said video data and then output said video data after processing; and
merging said digital video data and said analog video data into a signal mixing sources so that said digital video data and said analog video data can be displayed at a browse terminal in real time.

2. The realtime video display method of mixed signals as claimed in claim 1, wherein a data mixer is used to merge said digital video data and said analog video data for synchronous processing.

3. The realtime video display method of mixed signals as claimed in claim 1 further comprising a step of storing video into a database so that said digital 1 video data and said analog video data can be displayed at a browse terminal in real time after said step of merging said digital video data and said analog video data into a signal mixing data source.

4. The realtime video display method of mixed signals as claimed in claim 1, wherein said data fetch server processes said analog video data into a digital signal source for subsequent processing so that said analog video data can be viewed as one whose source is a digital monitoring device.

5. The realtime video display method of mixed signals as claimed in claim 1, wherein said monitoring system has a network communication device connected with said Internet/LAN/WAN for receiving said digital video data.

6. The realtime video display method of mixed signal as claimed in claim 1, wherein said monitoring system has a bus communication device connected with said transmission interface for receiving said analog video data.

7. The realtime video display method of mixed signals as claimed in claim 1, wherein said Internet/LAN/WAN is of TCP/IP architecture, and each of said digital monitoring devices has an individual IP address assigned to it.

8. The realtime video display method of mixed signals as claimed in claim 1, wherein said LAN/WAN is an Ethernet network.

9. The realtime video display method of mixed signals as claimed in claim 1, wherein said signal mixing different data sources is displayed on the same screen or on different screens.

10. The realtime video display method of mixed signal as claimed in claim 1, wherein said browse terminal is connected to said monitoring host via a network to make use of a network viewer for browsing said signal mixing different data sources.

11. The realtime video display method of mixed signal as claimed in claim 1, wherein said browse terminal can select captured images of a monitoring device to be displayed on the same monitoring screen, and the image source is from said analog monitoring device and/or said digital monitoring device.

12. The realtime video display method of mixed signal as claimed in claim 1, wherein said data mixer can receive video data of different video formats.

13. The realtime video display method of mixed signals as claimed in claim 1, which is integrated using the same software.

14. The realtime video display method of mixed signal as claimed in claim 1, wherein the format of said analog video is either NTSC or PAL.

15. The realtime video display method of mixed signal as claimed in claim 1, wherein said digital monitoring device is an IP camera.

16. The realtime video display method of mixed signal as claimed in claim 1, wherein the format of said digital video is MPEG, MPEG2, MPEG4, H.263, or H.264.

17. The realtime video display method of mixed signals as claimed in claim 1, wherein said the monitoring system can connect to the access control.

18. The realtime video display method of mixed signals as claimed in claim 1, wherein said the monitoring system can connect to the detectors.

19. The realtime video display method of mixed signals as claimed in claim 18, wherein said detectors comprise at least one selected from the group composed of magnetic contact, infrared detector, microwave spatial detector, glass vibration detector, smoke detector, temperature sensor, gas detector, flame detector, carbon monoxide detector, poisonous gas detector, emergency push-button, wireless help seeker, flash alarm, and indication light.

20. The realtime video display method of mixed signals as claimed in claim 1, wherein said transmission interface is one selected from the group composed of PCI, USB, and IEEE 1394.
